(19) United States
(12) Patent Application Publication
(10) Pub. No.: US 2009/0190876 A1
(43) Pub. Date: Jul. 30, 2009

(54) Waveguide polarizer and optical waveguide device

(75) Inventor: Masaharu Doi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/379,115

(22) Filed: Feb. 12, 2009

Related U.S. Application Data
(63) Continuation of application No. PCT/JP2006/316098, filed on Aug. 16, 2006.

(51) Int. Cl. G02B 6/00

(52) U.S. Cl. 385/11

(57) ABSTRACT

In the waveguide polarizer, an optical waveguide formed on a substrate includes a curved portion and there is provided an optical absorbing portion positioned on the outside in radial direction of the curved portion, and one of orthogonal polarization components of a light propagated through the optical waveguide ran out from the curved portion to the outside in radial direction is propagated through the optical absorbing portion to thereby be led to the outside of the optical waveguide, so that only the other polarization component is propagated to be output. Thus, it becomes possible to realize a miniaturized waveguide polarizer of low wavelength dependence.

This application is a continuation of PCT/JP2006/316098, filed on Aug. 16, 2006.

### FIELD

The embodiment discussed herein is related to a waveguide polarizer formed on an optical waveguide device used for optical communication, and in particular, to a waveguide polarizer formed on an optical waveguide containing a curved waveguide.

### BACKGROUND

An optical waveguide device used as an optical modulator may be provided with a polarizer formed on a waveguide substrate, in order to improve a polarization extinction ratio thereof. As a conventional waveguide polarizer, there has been known a configuration in which a metal film is formed on a waveguide so that one of vertical and horizontal polarization components (TM mode and TE mode) is absorbed by the metal film (refer to Japanese Laid-open Patent Publication No. 7-27935), a configuration in which a proton-exchanged waveguide is applied to a part of an optical waveguide to thereby realize a function as a polarizer (refer to Japanese Laid-open Patent Publication No. 6-94930) or the like.

However, each of the above configurations has a drawback in that a process other than a normal optical waveguide device manufacturing process is necessary.

To such a drawback, as illustrated in FIG. 11, there has been proposed a waveguide polarizer configured such that, on both sides of an optical waveguide 102 formed on a substrate 101 by metallic diffusion, rectangular radiation regions 103 also formed by metallic diffusion are disposed, and one of the TM mode and the TE mode propagated through the optical waveguide 102 is radiated in the rectangular radiation regions 103 (refer to Japanese Patent No. 2580127).

Further, as illustrated in FIG. 12, a configuration has also been proposed in which there is disposed a curved waveguide made up by connecting together a plurality of linear waveguide portions 201, 202, . . . so that the plurality of linear waveguide portions deviates from each other by a previously determined angle θ, and the length L of each linear waveguide portion is set to satisfy a relation of the following formulas, thereby realizing the polarization selectivity (refer to Japanese Laid-open Patent Publication No. 9-258047).

L=(2m+1)·λ/(2·Δn) (m=0, 1, 2, . . . )

Δn=Neff−Neff′

In the above formula, λ is a wavelength of light propagated through the waveguide, Neff is an effective refractive index of guide mode in the linear waveguide portion, for a polarized light to be propagated, and Neff′ is an average value of an effective refractive index of non-guide mode excited at a connection portion, for the polarized light to be propagated.

Further, for the optical waveguide device including the curved waveguide, there has been known a waveguide optical circulator in which the linear waveguide is combined with the curved waveguide so that the polarization dependence of the waveguide performance is reduced (refer to Japanese Patent No. 3690146).

However, the following problems still remain in the conventional waveguide polarizer as described above.

Namely, in the convention configuration illustrated in FIG. 11, the waveguide length of about 10 mm is necessary for realizing the polarization extinction ratio equal to or higher than 20 dB, and accordingly, the size of the optical waveguide device becomes larger. In addition, since the radiation regions 103 act on the light propagated through the optical waveguide 102, as directional couplers, the large wavelength dependence problematically occurs as illustrated in a relation of the polarization extinction ratio to the optical wavelength in FIG. 13.

Further, in the conventional configuration illustrated in FIG. 12, as apparent from the above relational expression, the optimum length L of each linear waveguide portion is different depending on the optical wavelength λ. Therefore, the large wavelength dependence problematically occurs also in the conventional configuration illustrated in FIG. 12.

### SUMMARY

In order to solve the above problems, according to one aspect of the embodiment, in a waveguide polarizer for transmitting only one of orthogonal polarization components of a light propagated through an optical waveguide formed on a substrate, the optical waveguide includes at least one curved portion and there is provided an optical absorbing portion positioned on the outside in radial direction of the curved portion, and the other polarization component ran out from the curved portion to the outside in radial direction is propagated through the optical absorbing portion to be led to the outside of the optical waveguide.

In the waveguide polarizer of the above configuration, depending on a spreading difference between modes of the orthogonal polarization components of the light propagated through the optical waveguide, the other polarization component runs out from the curved portion to the outside in radial direction, and is propagated through the optical absorbing portion to be led to the outside of the optical waveguide, so that only one of the polarization components is propagated through the optical waveguide to be output.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a plan view illustrating a configuration of a waveguide polarizer according to a first embodiment.

FIG. 2 is a sectional view illustrating a propagation state of each polarization mode in a linear portion in FIG. 1.

FIG. 3 is a sectional view illustrating a propagation state of each polarization mode in a curved portion in FIG. 1.

FIG. 4 is a graph illustrating one example in which a relation of a polarization extinction ratio to an optical wavelength is measured, in the first embodiment.

FIG. 5 is a graph illustrating a further example in which the relation of the polarization extinction ratio to the optical wavelength is measured, in the first embodiment.

FIG. 6 is a plan view illustrating a configuration of a waveguide polarizer according to a second embodiment.

FIG. 7 is a plan view illustrating a configuration of an application example relating to the second embodiment.

FIG. 8 is a plan view illustrating a configuration of a waveguide polarizer according to a third embodiment.

FIG. 9 is a plan view illustrating a configuration of a modified example relating to the third embodiment.

FIG. 10 is a plan view illustrating a configuration example for when the waveguide polarizer according to the embodiment is applied to an optical modulator.

FIG. 11 is a plan view illustrating a configuration example of a conventional waveguide polarizer.

FIG. 12 is a plan view illustrating a further configuration example of the conventional waveguide polarizer.

FIG. 13 is a graph illustrating a relation of a polarization extinction ratio to an optical wavelength in the conventional configuration in FIG. 11.

### DESCRIPTION OF EMBODIMENTS

There will be described embodiments for implementing the present invention, with reference to the accompanying drawings. The same reference numerals denote the same or equivalent parts in all drawings.

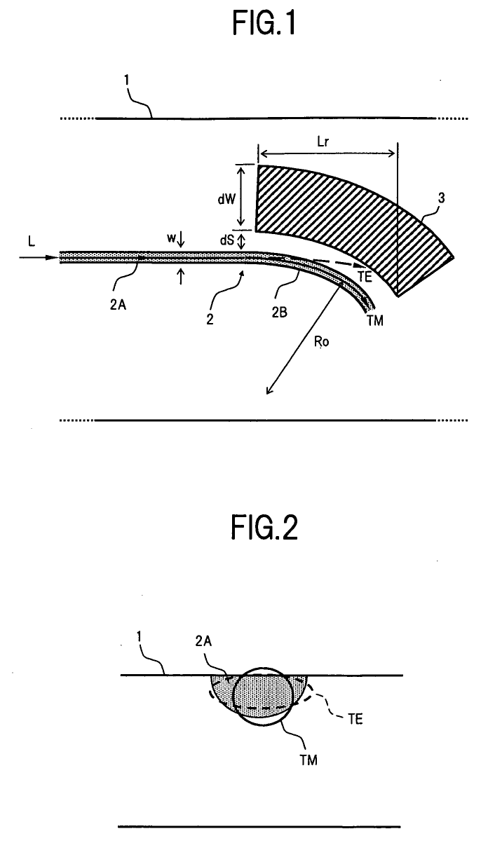

FIG. 1 is a plan view illustrating a configuration of a waveguide polarizer according to a first embodiment.

In FIG. 1, the waveguide polarizer in the first embodiment comprises: an optical waveguide 2 and an optical absorbing portion 3, which are formed by diffusing metal, such as titanium (Ti) or the like, onto a substrate 1 formed using lithium niobate (LiNbO₃), lithium tantalate (LiTaO₃) or the like of Z-cut, for about 10 hours.

The optical waveguide 2 includes a linear portion 2A and a curved portion 2B, so that an incident light L passes through the linear portion 2A, and thereafter, is propagated through the curved portion 2B. Herein, the width of each of the linear portion 2A and the curved portion 2B is w, and the curvature radius of the curved portion 2B is R₀.

The optical absorbing portion 3 is formed to be positioned on the outside in radial direction of the curved portion 2B, and also, to be separated from the curved portion 2B by a distance dS. Herein, the width of the optical absorbing portion 3 is dW and the length of the optical absorbing portion 3 along the curved portion 2B is Lr. However, in the case where the curvature radius R₀ of the curved portion 2B is large, the length Lr of the optical absorbing portion 3 may be the length in relation to an optical axis direction of the light propagated through the linear portion 2A as illustrated in FIG. 1.

In the waveguide polarizer of the above configuration, depending on a spreading difference between a TM mode and a TE mode in the curved portion 2B, only one of the modes is propagated through the curved portion 2B, whereas the other mode is absorbed in the optical absorbing portion 3.

To be specific, in the linear portion 2A formed on the Z-cut LiNbO₃ substrate 1 for example, as illustrated in a sectional view of FIG. 2, since the lateral confinement for the TE mode is lower than that for the TM mode, the TE mode is propagated while being spread in a laterally elliptical shape, whereas the TM mode is propagated while being spread in a circular shape. At this time, center axes of the TM and TE modes are positioned in the vicinity of the center of the section of the linear portion 2A.

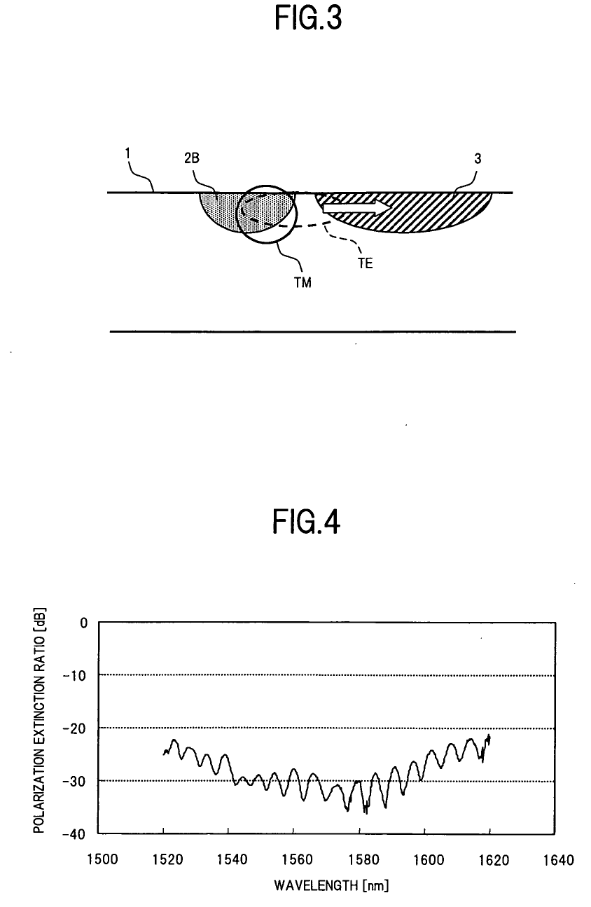

On the other hand, in the curved portion 2B, as illustrated in a sectional view of FIG. 3, the respective center axes of the TM mode propagated while being spread in the circular shape and the TE mode propagated while being spread in the elliptical shape are deviated to the outside in radial direction of the curved portion 2B. On the outside in radial direction of the curved portion 2B, the optical absorbing portion 3 is formed to be separated by the distance dS, so that the TE mode, which ran out from the curved portion 2B to the outside in radial direction to be leaked out to the optical absorbing portion 3, is propagated through the optical absorbing portion 3, and accordingly, does not practically return the curved portion 2B. As a result, the optical intensity of the TE mode propagated through the curved portion 2B is attenuated, and therefore, a function as a polarizer can be achieved.

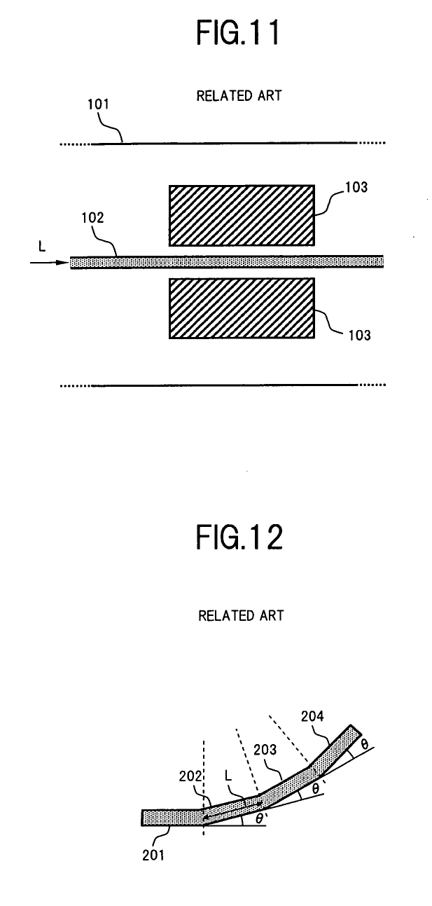

The above described configuration in which the optical absorbing portion 3 is disposed on the outside in radial direction of the curved portion 2B focusing on the spreading difference between the respective modes in the curved portion 2B is different from a conventional configuration illustrated in FIG. 11 in which radiation regions 103 formed on both sides of a linear waveguide 102 act as directional couplers, and therefore, the wavelength dependence can be reduced.

FIG. 4 illustrates one example in which a relation of a polarization extinction ratio to an optical wavelength is measured in the waveguide polarizer according to the first embodiment. Herein, the measurement is performed using an evaluation sample in which the width w of the linear portion 2A and of the curved portion 2B is 7 μm, the curvature radius R₀ of the curved portion 2B is 30 mm, the distance dS between the curved portion 2B and the optical absorbing portion 3 is 2 μm, the width dW of the optical absorbing portion 3 is 50 μm, and the length Lr of the optical absorbing portion 3 is 4 mm.

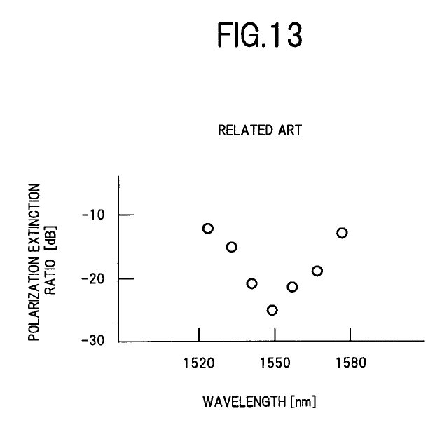

In a measurement result of FIG. 4, the polarization extinction ratio equal to or higher than 20 dB can be realized for over a wide wavelength range of 1520 nm to 1620 nm. On the other hand, in a measurement result in the conventional configuration illustrated in FIG. 13, the polarization extinction ratio equal to or higher than 20 dB can be realized only in a narrow wavelength range of 1540 nm to 1560 nm. Consequently, it is understood that by applying the configuration of FIG. 1, the wavelength dependence of the waveguide polarizer can be effectively reduced.

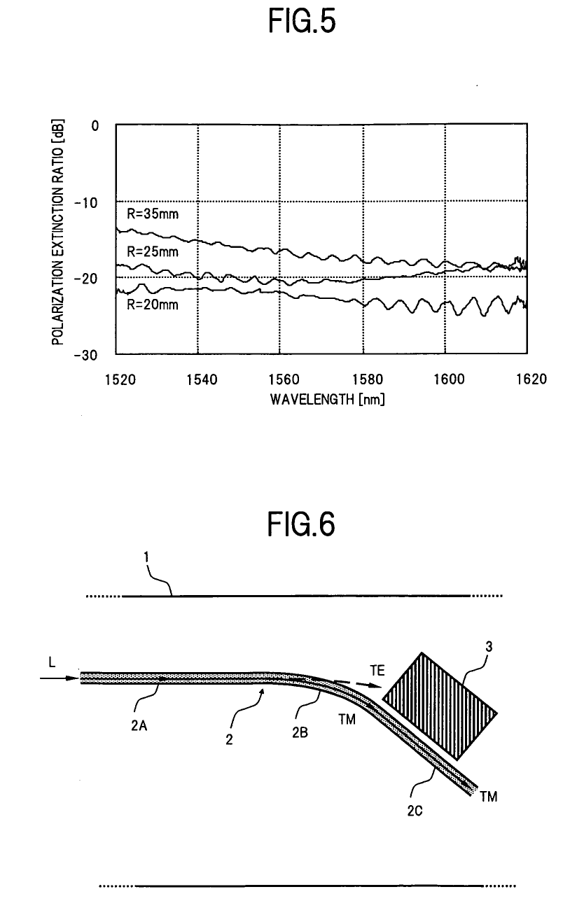

Further, relating to the evaluation sample used in the measurement of FIG. 4, FIG. 5 illustrates a similar measurement result for when the curvature radius R₀ of the curved portion 2B is changed to 20 mm, 25 mm or 30 mm, and also, the length Lr of the optical absorbing portion 3 is changed from 4 mm to 2 mm. According to the measurement result in FIG. 5, it is understood that even in the case where the length Lr of the optical absorbing portion 3 is shortened to 2 mm, by changing the curvature radius R₀ of the curved portion 2B to 20 mm, the polarization extinction ratio equal to or higher than 20 dB can be realized for over the wide wavelength range of 1520 nm to 1620 nm. This is because the TE mode which runs out from the curved portion 2B to the outside in radial direction is increased as a result that the curvature radius R₀ of the curved portion 2B is reduced, and accordingly, even if the length Lr of the optical absorbing portion 3 is short, the TE mode can be effectively absorbed. Thus, if the curvature radius R₀ of the curved portion 2B and the length Lr of the optical absorbing portion 3 are reduced, the size of the entire waveguide polarizer can be made smaller.

As described in the above, according to the first embodiment, it becomes possible to realize a miniaturized waveguide polarizer of low wavelength dependence, by applying a manufacturing process similar to that for a normal optical waveguide device.

Incidentally, in the first embodiment, the description has been made on the case where LiNbO₃, LiTaO₃ or the like is used as the material of the substrate 1. However, the present invention is not limited thereto, and it is possible to apply a known substrate material of different refractive indexes between the TM mode and the TE mode, which is used for the optical waveguide device. Further, there has been illustrated one example in which the optical waveguide 2 and the optical absorbing portion 3 are formed on the substrate 1 by diffusing the metal of Ti or the like. However, it is surely possible to form the optical waveguide 2 and the optical absorbing portion 3 by a known method other than the metal diffusion. Furthermore, the optical absorbing portion 3 may be realized by forming a metal film on a surface of the substrate 1 directly or via a thin buffer layer. In this case, unnecessary polarization components are absorbed by the metal film.

Next, there will be described a second embodiment.

FIG. 6 is a plan view illustrating a configuration of a waveguide polarizer according to the second embodiment.

In FIG. 6, the waveguide polarizer in the second embodiment is configured such that the optical waveguide 2 formed on the substrate 1 includes linear portions 2A and 2C on the front and rear of the curved portion 2B, and in the case where the light is propagated through the linear portion 2A, the curved portion 2B and the linear portion 2C in this sequence, the optical absorbing portion 3 is formed in a region which is positioned on the side of the linear portion 2C corresponding to the outside in radial direction of the curved portion 2B and also is at a distance from the linear portion 2C.

In the waveguide polarizer of the above configuration, the respective polarization modes are propagated through the linear portion 2A and the curved portion 2B in a state similar to that in FIG. 2 and FIG. 3, so that the TM mode is led from the curved portion 2B to the linear portion 2C, whereas the TE mode runs out from the curved portion 2B to the outside in radial direction and the most part thereof is leaked out to the optical absorbing portion 3 to be propagated through the optical absorbing portion 3. As a result, the optical intensity of the TE mode propagated through the linear portion 2C is attenuated, and therefore, the function as the polarizer can be achieved.

Accordingly, in the second embodiment of the optical waveguide structure including the linear portions 2A and 2C on the front and rear of the curved portion 2B, it is also possible to obtain effects similar to those in the first embodiment.

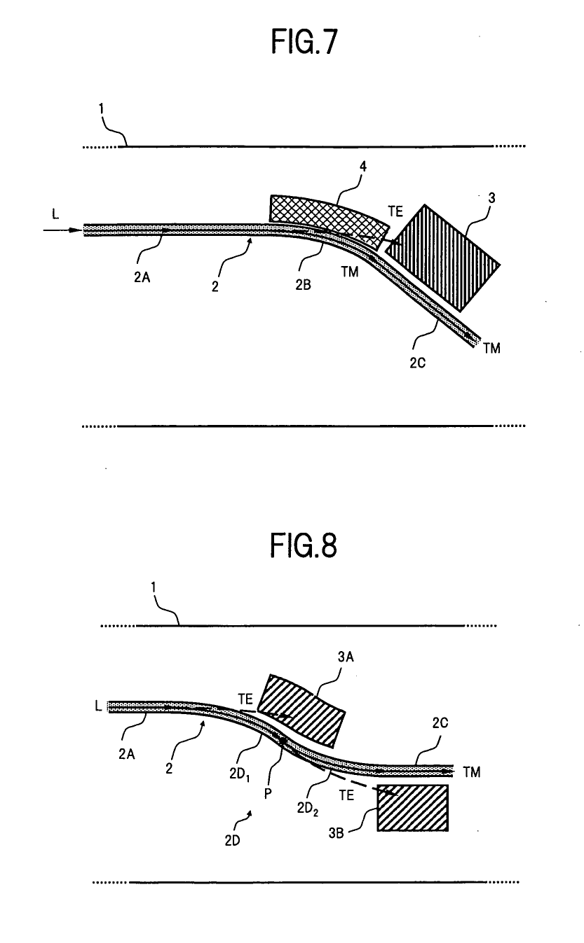

Incidentally, as an application example of the second embodiment, as illustrated in FIG. 7, a groove portion 4 may be disposed on a region which is positioned on the outside in radial direction of the curved portion 2B and also is in the vicinity of the curved portion 2B. This groove portion 4 is formed by etching or the like on the substrate 1. In such a configuration, the TM mode is effectively confined in the curved portion 2B, whereas the TE mode ran out from the curved portion 2B to the outside in radial direction passes through the groove portion 4 to be propagated through the optical absorbing portion 3. Thus, by disposing the above groove portion 4, it becomes possible to make the curvature radius R₀ of the curved portion 2B smaller without increasing a loss of the TM mode, to thereby further miniaturize the waveguide polarizer.

Herein, the description has been made on the Z-cut LiNbO₃ substrate. However, a Y-propagation LiNbO₃ substrate of X-cut may be used. In this case, contrary to the Z-cut substrate, the TM mode is laterally spread compared with the TE mode, and therefore, a polarizer of TM-cut can be realized.

Next, there will be described a third embodiment.

FIG. 8 a plan view illustrating a configuration of a waveguide polarizer according to the third embodiment.

In FIG. 8, the waveguide polarizer in the third embodiment is configured such that the optical waveguide 2 formed on the substrate 1 includes a S-shape portion 2D, and in the case where the light is propagated through the linear portion 2A, the S-shape portion 2D and the linear portion 2C in this sequence, an optical absorbing portion 3A is formed in a region which is positioned on the outside in radial direction of a curved part 2D₁ on the optical input side from an inflection point P of the S-shape portion 2D and also is at a distance from the S-shape portion 2D in the vicinity of the inflection point P, and also, an optical absorbing portion 3B is formed in a region which is positioned on the side of the linear portion 2C corresponding to the outside in radial direction of a curved part 2D₂ on the optical output side from the inflection point P of the S-shape portion 2D and also is at a distance from the linear portion 2C.

In the waveguide polarizer of the above configuration, the respective polarization modes are propagated through the linear portion 2A, and the former curved part 2D₁ of the S-shape portion 2D in a state similar to that in FIG. 2 and FIG. 3, so that the TM mode is led to the latter part 2D₂ of the S-shape portion 2D, whereas the TE mode runs out from the former curved part 2D₁ of the S-shape portion 2D to the outside in radial direction and the most part thereof is leaked out to the optical absorbing portion 3A to be propagated through the optical absorbing portion 3A. Further, the TE mode which has passed through the inflection point P without being propagated through the optical absorbing portion 3A, runs out from the latter curved part 2D₂ of the S-shape portion 2D to the outside in radial direction and the most part thereof is leaked out to the optical absorbing portion 3B to be propagated through the optical absorbing portion 3B. Incidentally, the TM mode is led to the linear portion 2C from the latter curved part 2D₂ of the S-shape portion 2D. As a result, the optical intensity of the TE mode propagated through the linear portion 2C is attenuated, and therefore, the function as the polarizer can be achieved.

Accordingly, in the third embodiment of the optical waveguide structure including the S-shape portion 2D, it is also possible to obtain effects similar to those in the first embodiment. Further, the TE mode can be attenuated at two sites of the optical absorbing portion 3A disposed in the vicinity of the inflection point P of the S-shape portion 2D and the optical absorbing portion 3B disposed on the side of the linear portion 2C, and therefore, it is possible to realize a further excellent polarization extinction ratio.

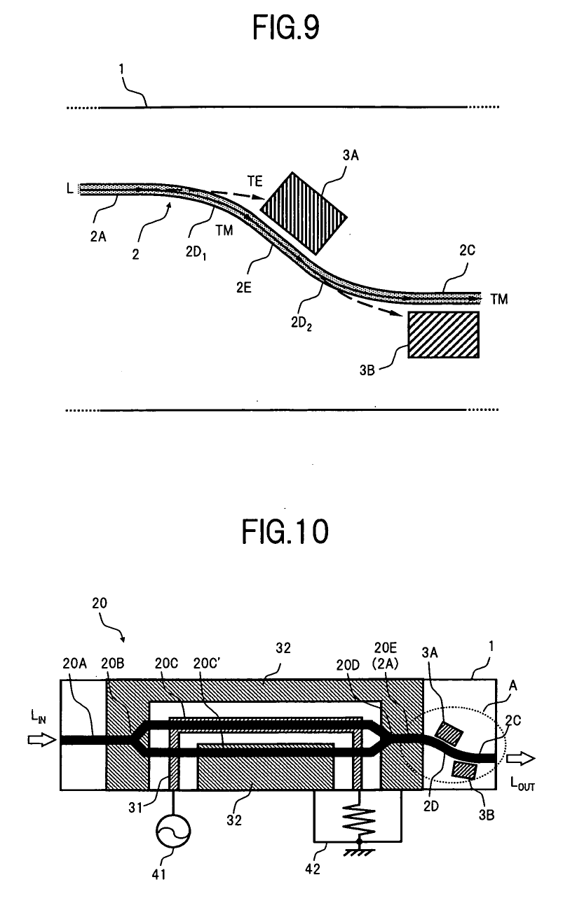

Incidentally, as a modified example of the third embodiment, as illustrated in FIG. 9, a linear portion 2E may be formed between the former curved part 2D₁ of the S-shape portion 2D and the latter curved part 2D₂ thereof, so that the optical absorbing portion 3A is formed in a region which is positioned on the side of the linear portion 2E corresponding to the outside in radial direction of the former curved part 2D₁ of the S-shape portion 2D and also is at a distance from the linear portion 2E. In such a configuration, since a shape of the optical absorbing portion 3A is simplified, it becomes possible to easily perform the pattern designing.

Next, there will be described one example of optical waveguide devices to which the waveguide polarizer according to the embodiment is applied.

FIG. 10 is a plan view illustrating a configuration example in which the waveguide polarizer of the embodiment is applied to an optical modulator.

In the configuration example illustrated in FIG. 10, the waveguide polarizer in the third embodiment illustrated in FIG. 8 is incorporated into an output part A of a known Mach-Zehnder optical modulator. To be specific, a Mach-Zehnder optical waveguide 20 comprising: an input waveguide 20A; a branching portion 20B; branching waveguides 20C, 20C′; a multiplexing portion 20D; and an output waveguide 20E, is formed on the substrate 1 by the metal diffusion, and further, the output waveguide 20E of the Mach-Zehnder optical waveguide 20 is also used as the linear portion 2A of the optical waveguide 2 in the above waveguide polarizer, so that the S-shape portion 2D and the linear portion 2C, and the optical absorbing portions 3A and 3B, are formed on the substrate 1 by the metal diffusion. Further, on the Mach-Zehnder optical waveguide 20, a signal electrode 31 and an earth electrode 32 are formed along the branching waveguides 20C and 20C′, so that a modulation signal output from a drive circuit 41 is supplied to one end of the signal electrode 31. A termination circuit 42 is connected to the other end of the signal electrode 31.

According to the optical modulator of the above configuration, a light L_{IN} input to the Mach-Zehnder optical waveguide 20 is modulated in accordance with the modulation signal applied on the signal electrode 31, and only one (for example, the TM mode) of orthogonal polarization components contained in the modulation signal is propagated through the S-shape portion 2D to be output from the linear portion 2C. As a result, it becomes possible to realize a miniaturized Mach-Zehnder optical modulator of an excellent polarization extinction ratio.

In the above description, there has been illustrated one example in which the known Mach-Zehnder optical modulator is combined with the waveguide polarizer in the third embodiment. However, it is surely possible to combine the known Mach-Zehnder optical modulator with the waveguide polarizer in each of the remaining embodiments. Further, the optical waveguide device to which the waveguide polarizer of the present invention can be applied is not limited to the Mach-Zehnder optical modulator, and the waveguide polarizer of the present invention is effective for various optical waveguide devices each in which only one of orthogonal polarization components is processed. Furthermore, in the above example, the waveguide polarizer is formed on the output side. However, the waveguide polarizer can be formed on the input side or a halfway site at which the curved waveguide is formed.

What is claimed is:

1. A waveguide polarizer for transmitting only one of orthogonal polarization components of a light propagated through an optical waveguide formed on a substrate,
wherein the optical waveguide comprises at least one curved portion and there is provided an optical absorbing portion positioned on the outside in radial direction of the curved portion, and the other polarization component ran out from the curved portion to the outside in radial direction is propagated through the optical absorbing portion to be led to the outside of the optical waveguide.

2. A waveguide polarizer according to claim 1,
wherein the optical waveguide comprises a linear portion input with the light at one end thereof and a curved portion connected to the other end of the linear portion at one end thereof, and
the optical absorbing portion is formed in a region which is positioned on the outside in radial direction of the curved portion and also is at a distance from the curved portion.

3. A waveguide polarizer according to claim 1,
wherein the optical waveguide comprises: a first linear portion input with the light at one end thereof; the curved portion connected to the other end of the first linear portion at one end thereof; and a second linear portion connected to the other end of the curved portion at one end thereof, and
the optical absorbing portion is formed in a region which is positioned on the side of the second linear portion corresponding to the outside in radial direction of the curved portion and also is at a distance from the second linear portion.

4. A waveguide polarizer according to claim 3, further comprising a groove portion formed in a region which is positioned on the outside in radial direction of the curved portion and also is in the vicinity of the curved portion.

5. A waveguide polarizer according to claim 1,
wherein the optical waveguide comprises: a first linear portion input with the light at one end thereof; a S-shape portion connected to the other end of the first linear portion at one end thereof; and a second linear portion connected to the other end of the S-shape portion at one end thereof, and
the optical absorbing portion is formed in a first region which is positioned on the outside in radial direction of a first curved part on the optical input side from an inflection point of the S-shape portion and also is at a distance from the S-shape portion in the vicinity of the inflection point.

6. A waveguide polarizer according to claim 1,
wherein the optical waveguide comprises: a first linear portion input with the light at one end thereof; a S-shape portion connected to the other end of the first linear portion at one end thereof; and a second linear portion connected to the other end of the S-shape portion at one end thereof, and
the optical absorbing portion is formed in a second region which is positioned on the side of the second linear portion corresponding to the outside in radial direction of a second curved part on the optical output side from an inflection point of the S-shape portion and also is at a distance from the second linear portion.

7. A waveguide polarizer according to claim 1,
wherein the optical waveguide comprises: a first linear portion input with the light at one end thereof; a S-shape portion connected to the other end of the first linear portion at one end thereof; and a second linear portion connected to the other end of the S-shape portion at one end thereof, and
the optical absorbing portion is formed in a first region which is positioned on the outside in radial direction of a first curved part on the optical input side from an inflection point of the S-shape portion and also is at a distance from the S-shape portion in the vicinity of the inflection point, and also, is formed in a second region which is positioned on the side of the second linear portion corresponding to the outside in radial direction of a second curved part on the optical output side from the inflection point of the S-shape portion and also is at a distance from the second linear portion.

8. A waveguide polarizer according to claim 5,
wherein the optical waveguide comprises a third linear portion between the first and second curved parts of the S-shape portion, and
in place of the first region, the optical absorbing portion is formed in a third region which is positioned on the side of the third linear portion corresponding to the outside in radial direction of the first curved part of the S-shape portion and also is at a distance from the third linear portion.

9. A waveguide polarizer according to claim 1,
wherein the optical waveguide and the optical absorbing portion are formed by diffusing metal onto the substrate.

10. A waveguide polarizer according to claim 1,
wherein the optical absorbing portion is a metal film formed on a surface of the substrate.

11. An optical waveguide device comprising a waveguide polarizer according to claim 1.

12. An optical waveguide device according to claim 11,
wherein the waveguide polarizer is connected to an output waveguide of a Mach-Zehnder optical modulator.

13. An optical waveguide device according to claim 11,
wherein the waveguide polarizer is connected to an input waveguide of a Mach-Zehnder optical modulator.
